(19) United States
(12) Patent Application Publication
(10) Pub. No.: US 2020/0103354 A1
(43) Pub. Date: Apr. 2, 2020

(54) DEVICE AND METHOD FOR PERCEIVING AN ACTUAL SITUATION IN AN INTERIOR OF A PEOPLE MOVER

(71) Applicant: ZF Friedrichshafen AG, Friedrichshafen (DE)

(72) Inventors: Jörg Angermayer, Friedrichshafen (DE); Christoph Kolesch, Biberach (DE); Christian Herzog, Friedrichshafen (DE); Anatol Weidenbach, Nonnenhorn (DE); Sarah Weissenberger, Friedrichshafen (DE)

(73) Assignee: ZF Friedrichshafen AG, Friedrichshafen (DE)

(21) Appl. No.: 16/584,253

(22) Filed: Sep. 26, 2019

(30) Foreign Application Priority Data
Sep. 28, 2018 (DE) 102018216761.3

(51) Int. Cl. G01N 21/94; G06K 9/00; G07C 5/00

(52) U.S. Cl. CPC G01N 21/94; G06K 9/00832; G05D 1/021; G01N 2021/945; G07C 5/006

(57) ABSTRACT

A device for perceiving an actual state of an interior of a people mover may include at least one imaging sensor for perceiving the actual state of the interior and an evaluation device that is configured to obtain a target state of the interior. The evaluation device may be configured to compare the actual state with the target state in order to determine a difference between the actual state and the target state, and wherein the evaluation device is configured to generate a signal for informing an operator of the people mover of the actual state based on the difference. An interface may also be included for sending the signal to the operator.

### RELATED APPLICATIONS

This application claims the benefit and priority of German Patent Application DE 10 2018 216 761.3, filed Sep. 28, 2018, which is incorporated by reference herein in its entirety.

### TECHNICAL FIELD

The present disclosure relates to a device and method for perceiving an actual state of an interior of a people mover.

### BACKGROUND

Vehicles for transporting people and goods are known from the prior art. In particular, vehicles for transporting people are small busses for transporting people short distances, e.g. in cities, factory premises, university campuses, airports or trade fairs, also referred to as people movers.

In the course of automation, it is important to monitor the interior of a people mover. Currently, busses in local public transport are equipped with cameras, for example, for monitoring the entryways of the bus.

In public transport, the vehicles, e.g. busses, become dirty over time. When a bus needs to be cleaned currently depends on the subjective perceptions of the bus driver. There are no longer any bus drivers, however, with autonomous driving.

In view of the above, the present disclosure provides a device to automate the monitoring of the interiors of small busses with regard to cleanliness and/or damage, in order to increase safety when transporting people.

### BRIEF DESCRIPTION OF THE DRAWINGS

The depicted embodiments shall be explained below based on the following figures and the associated descriptions thereof, based on exemplary embodiments. Therein:

FIG. 1 shows an exemplary embodiment of a people mover;

FIG. 2 shows an exemplary embodiment of a device according to the invention; and

FIG. 3 shows an exemplary embodiment of a method.

### DETAILED DESCRIPTION

In view of the above background, the present disclosure provides a device to automate the monitoring of the interiors of small busses with regard to cleanliness and/or damage, in order to increase safety when transporting people.

The device may be designed to perceive an actual state of an interior of a people mover. The device comprises at least one imaging sensor for perceiving the actual state of the interior. The device also comprises an evaluation system. The evaluation system is configured to obtain a target state of the interior. The evaluation system is also configured to compare the actual state with the target state, in order to determine if the actual state differs from the target state. The evaluation system is also configured to generate a signal, depending on the difference, in order to inform an operator of the people mover of the actual state. The device also contains an interface for transmitting the signal to the operator.

A people mover may be a small bus that can be developed and used universally, which can be equipped in particular for local public transport. The people mover is used to transport people short distances, e.g. in cities, on factory premises, on campuses of research facilities, e.g. universities or non-university facilities, and in airports or trade fairs. The dimensions of the people mover are 4.65×1.95×2.50 meters (length, width, height). The people move preferably contains 10 seats and 5 spaces for standing. The dimensions of the passenger cabin, i.e. the space the passengers enter and exit in the people mover and remain in during transport, are 3.00×1.85×2.20 meters (length, width, height). The empty weight of the people mover is 2 tons, by way of example. The people mover preferably comprises an electric drive system, preferably an electric axle drive with an output of 150 kW, and has a battery capacity for use of up to 10 hours. The people mover can be operated automatically, preferably up to the automation level SAE level 5, i.e. fully automated or autonomously operable.

The automatically operable people mover comprises a technological apparatus, in particular an environment perception system, a supercomputing control unit with artificial intelligence, and intelligent actuators, which can control the people mover with a vehicle control system when a corresponding automatic driving function has been activated, in particular a highly or fully automated driving function according to the standard SAE J3016, in order to carry out driving tasks, including longitudinal and transverse guidance. The people mover is equipped in particular for SAE levels 3, 4 and 5. In particular in a transition period to highly/fully automated driving, it may be used at SAE levels 3 and 4, in order to subsequently be used at SAE level 5.

There is still a driver, however, at SAE levels 3 and 4, the so-called safety driver, who can respond to demands to intervene, i.e. it is possible to assume control. People movers for SAE levels 3 and 4 comprise a driver cabin for the safety driver. At SAE level 5, the driver cabin is no longer necessary. The assembly can still be used without a driver cabin.

An imaging sensor is configured to generate a digital image of an object. An image sensor in a digital camera is an imaging sensor, for example. The imaging sensor is advantageously a TOF sensor, i.e. a time-of-flight sensor. In a TOF sensor, each pixel of the sensor records incident light and measures the runtime that the light requires to travel from a source to an object and from the object back to the pixels. The TOF sensor then advantageously generates a depth of field image with 3D data.

The actual state of the interior is the currently recorded state of the interior. By way of example, an interior with newspapers flying around, or an interior with dirty or damaged seats are actual states. The target state of the interior is a predefined state. By way of example, a clean state or an undamaged state of the interior are target states. The actual state is recorded by means of the imaging sensor in the form of a digital image.

An evaluation system is a device that processes input data and outputs a result of this processing. In particular, an evaluation system is an electronic circuit, e.g. a central processing unit or a graphics processor. The evaluation system is preferably implemented as a system-on-a-chip of the imaging sensor, i.e. all, or at least a majority of the functions are integrated on the chip. The chip advantageously comprises a multi-core processor with numerous central processing processors, for example, referred to as a central processing unit in English, abbreviated CPU. The chip also advantageously comprises numerous graphics processors, referred to in English as a graphics processing unit, abbreviated GPU. Graphics processors are particularly advantageously suited for parallel processing of sequences. The evaluation system can be scaled with such a construction, i.e. the evaluation system can be adapted to different SAE levels.

The evaluation system processes digital images which depict the actual state of the interior, and digital images that depict the target state of the interior. The digital images of the target states are obtained, for example, with the imaging sensor, or retrieved by the evaluation system from a cloud service.

An interface is a mechanical and/or electrical component between at least two functional units, at which an exchange of logical values takes place, e.g. data, or physical values, e.g. electrical signals, either unidirectionally or bidirectionally. The exchange can be analog or digital. The exchange can preferably be wireless or hard-wired.

An operator maintains and provides a people mover or a fleet of people movers. The operator defines the target state of the interior.

The operator is automatically informed with the device when the actual state of the interior of one or more people movers differs from the target state. This information is issued depending on the extent of the difference between the actual state and the target state. As a result, the operator does not need to be informed of every slight difference of the actual state from the target state, but only when the difference exceeds a specific tolerance level. The tolerance level is preferably defined by the operator. By way of example, the operator should first be informed when at least 30% of the floor surface is covered by loose newspapers.

The signal sent to the operator is a visual and/or acoustic signal, for example.

The device is configured to be installed in a people mover such that the field of view of the imaging sensor perceives as much of the interior of the people mover as possible.

The evaluation system is preferably configured to execute an image recognition algorithm. The image recognition algorithm comprises software code segments for detecting cleanliness and/or damages in the image recordings of the interior. The evaluation system is also configured to determine the degree of cleanliness and/or damage in the interior based on the comparison of the actual state with the target state. The image recognition algorithm can be executed in a computer program. The image recognition algorithm perceives objects in the digital photograph based in particular on a background image in which these objects are not present. In particular, the image recognition algorithm perceives objects of arbitrary sizes placed on a flat surface. By way of example, the image recognition algorithm recognizes newspapers, packaging, drinks, food, and discarded drinks and/or food left on the floor and/or seats in the interior of the people mover. The image recognition algorithm also perceives damages in the interior, e.g. damaged seat upholstery.

In a particularly advantageous embodiment, the evaluation system is configured to determine the difference between the actual state and the target state by means of artificial intelligence.

Artificial intelligence is a generic term for the automation of intelligent behavior. By way of example, an intelligent algorithm learns to respond appropriately to new information. An artificial neural network, referred to in English as an artificial neural network, is an intelligent algorithm. An intelligent algorithm is configured to learn to respond appropriately to new information. The artificial neural network learns, for example, to recognize and classify newspapers, packaging, drinks, food, and the remains of food and/or drinks, without comparison with an image of the target state.

An actual state of an interior of a people mover is perceived with the following method. The method may include the following steps:

perceiving the actual state of the interior with the imaging sensor,

obtaining a target state of the interior,

comparing the actual state with the target state,

determining a difference between the actual state and the target state,

generating a signal informing an operator of the people mover of the actual state based on the difference, and

sending the signal to the operator.

As a result, the operator is automatically informed when the actual states of the interior of one or more people movers differs from the target state.

A device in accordance with this specification may be used for executing the method.

By perceiving the extent of cleanliness and damages, the cleanliness and maintenance of interiors of people movers is automatically monitored. The safety when transporting people is also increased, because these people ideally enter a clean interior, and are not injured as a result of poor cleanliness and/or damages.

Identical reference symbols indicate identical or functionally similar components in the figures. For purposes of clarity, only those reference symbols relevant to the understanding of the respective figure are given in the individual figures. The components not provided with reference symbols retain their original significance and function therein.

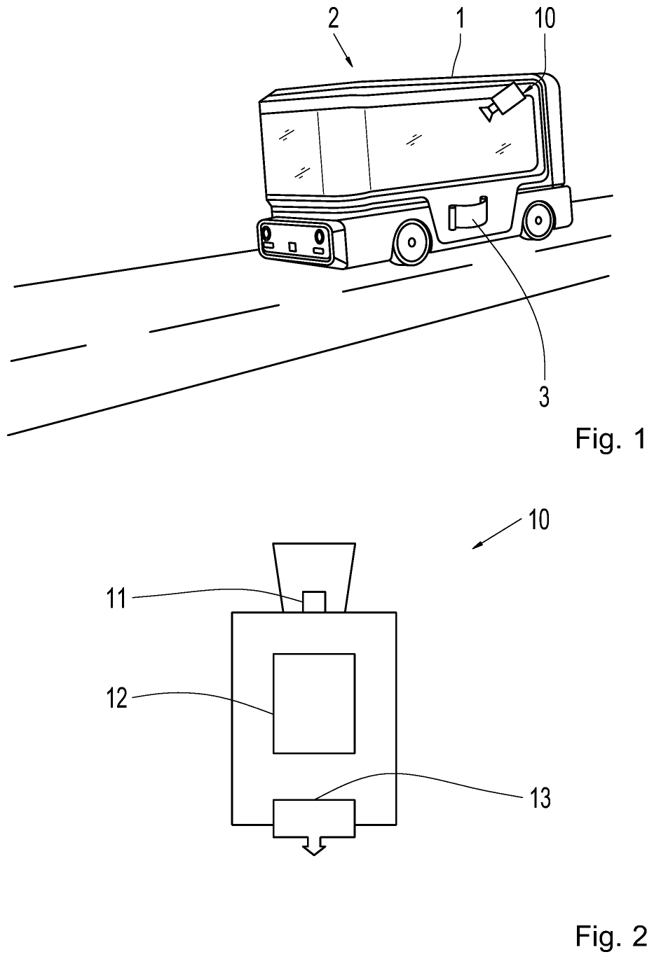

FIG. 1 shows a people mover 2. A device 10 is installed in an interior 1 of the people mover 2. The device 10 perceives the interior 1. In particular, the device 10 monitors the cleanliness and/or damages in the interior 1. An object 3 lies on the floor of the interior 1, e.g. a newspaper. This is an actual state. In this state, the interior 1 is not clean due to the newspaper lying on the floor. A target state is a clean state in which no newspapers are lying on the floor. The device 10 compares the actual state with the target state.

The device 10 is shown in detail in FIG. 2. The imaging sensor 11 is, e.g., an image sensor in a digital camera. An image from the imaging sensor 11 of the current interior 1, thus the actual state, is sent to an evaluation system 12. An image of a target state is stored in the evaluation system 12, e.g. in the form of an image from the imaging sensor 11 of a clean state of the interior 1. The evaluation system 12 executes an image recognition algorithm, with which the object 3 that is present in the image of the actual state is recognized, e.g. in a comparison with the image of the target state, in which the object 3 is not present. The evaluation system 12 generates a visual signal that shows the object 3, together with an acoustic signal that indicates that the object 3 is present in the interior 1 and that the interior 1 needs to be cleaned. These signals are sent to the operator of the people mover via the interface 13, e.g. a WLAN interface.

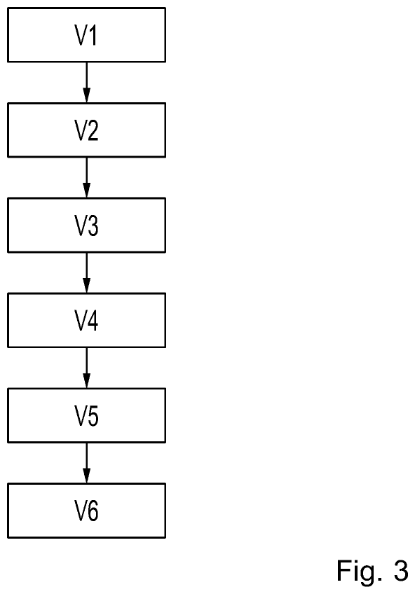

FIG. 3 shows, by way of example, the fundamental method. In a first step V1, the actual state of the interior 1 is perceived with the imaging sensor 11. In a second step V2, the target state of the interior 1 is obtained. A comparison of the actual state with the target state takes place in step V3. The determination of a difference between the actual state and the target state takes place in step V4. In step V5, a signal is generated for informing an operator of the people mover 2 of the actual state based on the difference. The signal is sent to the operator in step V6.

### REFERENCE SYMBOLS

1 interior
2 people mover
3 object
10 device
11 imaging sensor
12 evaluation system
13 interface
V1-6 steps of the method

1. A device for perceiving an actual state of an interior of a people mover, the device comprising:
at least one imaging sensor for perceiving the actual state of the interior;
an evaluation device that is configured to obtain a target state of the interior,
wherein the evaluation device is configured to compare the actual state with the target state in order to determine a difference between the actual state and the target state, and wherein the evaluation device is configured to generate a signal for informing an operator of the people mover of the actual state based on the difference; and
an interface for sending the signal to the operator.

2. The device according to claim 1, wherein the evaluation system is configured to execute an image recognition algorithm, and wherein image recognition algorithm software code segments are included for recognizing cleanliness and/or damages in the image of the interior.

3. The device according to claim 2, wherein the evaluation system is configured to determine the extent of cleanliness a of the interior based on the comparison of the actual state with the target state.

4. The device according to claim 2, wherein the evaluation system is configured to determine the extent of damage of the interior based on the comparison of the actual state with the target state.

5. The device according to claim 1, wherein the evaluation system is configured to determine the difference between the actual state and the target state using artificial intelligence.

6. The device according to claim 1, wherein the signal is an acoustic signal.

7. The device according to claim 1, wherein the signal is a visual signal.

8. A method for perceiving an actual state of an interior of a people mover, the method comprising the steps of:
perceiving an actual state of the interior with an imaging sensor;
obtaining a target state of the interior;
comparing the actual state with the target state;
determining a difference between the actual state and the target state;
generating a signal for informing an operator of the people mover of the actual state based on the difference; and
sending the signal to the operator.

9. A device for perceiving an actual state of an interior of a people mover, the device comprising:
a camera;
at least one imaging sensor within the camera for generating an image of the actual state of the interior;
an evaluation device that is configured to obtain a target state of the interior,
wherein the evaluation device is configured to compare the actual state with the target state in order to determine a difference between the actual state and the target state; and
an interface for sending at least one of a visual and acoustic signal to an operator of the people mover when the actual state is different than the target state.

10. The device according to claim 9, wherein the evaluation system is configured to execute an image recognition algorithm, and wherein image recognition algorithm software code segments are included for recognizing cleanliness and/or damages in the image of the interior.

11. The device according to claim 10, wherein the evaluation system is configured to determine the extent of cleanliness of the interior based on the comparison of the actual state with the target state.

12. The device according to claim 10, wherein the evaluation system is configured to determine the extent of damage of the interior based on the comparison of the actual state with the target state.

13. The device according to claim 9, wherein the evaluation system is configured to determine the difference between the actual state and the target state using artificial intelligence.
